(19) United States
(12) Patent Application Publication
(10) Pub. No.: US 2010/0045602 A1
(43) Pub. Date: Feb. 25, 2010

(54) POSITION INPUT DEVICE WITH ANCHORAGE

(75) Inventors: Adam Pilkington, Southampton (GB); Simon C.E. Rowland, Winchester (GB)

Correspondence Address: IBM - EU c/o Myers Andras Sherman LLP, 19900 MacArthur Blvd., Suite 1150, Irvine, CA, 92612, US

(73) Assignee: International Business Machines Corporation, Armonk, NY (US)

(21) Appl. No.: 12/197,934

(22) Filed: Aug. 25, 2008

(51) Int. Cl. G06F 3/033

(52) U.S. Cl. 345/163

(57) ABSTRACT

A position input device is provided. The input device includes a mouse module configured for providing position information, the mouse including a body, and a skirt element attached to the mouse body and extending from a lower surface of the mouse body, for maintaining the mouse in an essentially stationary position on a support surface by holding the skirt against a surface under the mouse module.

### BACKGROUND OF THE INVENTION

1. Field of the Invention

The invention relates to input devices and in particular to mice and joysticks.

2. Background Information

Input devices, such as mice and joysticks are popular devices for interacting with electronic devices, such as computers and game consoles. A computer mouse is frequently combined with other input options such as a joystick in order to increase the versatility of the hardware accessory. However, a typical mouse is designed to move easily over most surfaces, which causes instability if the other input option requires that the mouse be stationary.

### BRIEF SUMMARY OF THE INVENTION

The invention provides a position input device with anchorage. One embodiment comprises a mouse module configured for providing position information, the mouse including a body, and a skirt element attached to the mouse body and extending from a lower surface of the mouse body, for maintaining the mouse in an essentially stationary position on a support surface by holding the skirt against a surface under the mouse module.

The skirt may be positioned and configured on the mouse body to allow maintaining the mouse against the support surface by the heel of a user hand. The skirt may be substantially planar and extending from the mouse body at a position for resting the heel of a user hand thereon. Further, the skirt may be detachably attached to the mouse body.

These and other features, aspects and advantages of the invention will become understood with reference to the following description, appended claims and accompanying figures.

### BRIEF DESCRIPTION OF THE DRAWINGS

FIG. 1 shows a top view of an input device with a skirt anchorage, according to an embodiment of the invention.

FIG. 2 shows a side view of the input device of FIG. 1.

FIG. 3 shows a perspective view of the input device of FIG. 1 with a user's hand pressing on the skirt to maintain the input device stationary on a support surface.

### DETAILED DESCRIPTION OF THE INVENTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of input devices, as well as operation and/or component parts thereof. While the following description will be described in terms of a combined mouse and joystick device for clarity and to place the invention in context, it should be kept in mind that the teachings herein may have broad application to all types of systems, devices and applications.

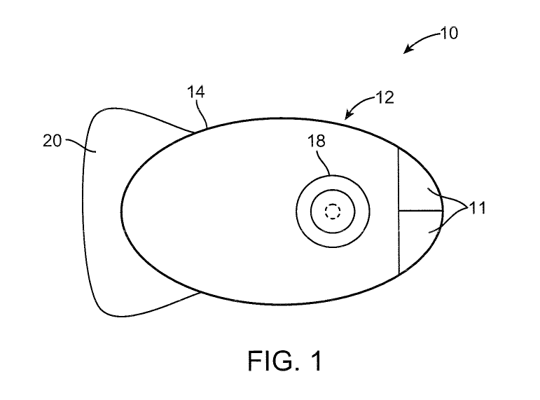

This invention provides a position input device with anchorage. One embodiment comprises a computer mouse with a skirt for anchorage on a support surface, such as in low friction surfaces. FIG. 1 shows a top view of an example input device 10 including a mouse 12 having a body 14.

The device 10 further includes a skirt 20 for anchorage of the mouse 12, according to the invention. The skirt 20 is planar and is attached to the body 14, such that the heel of the hand of a user can rest on the skirt 20. Pressure on the skirt 20 maintains the mouse in place on a support surface under the mouse and skirt.

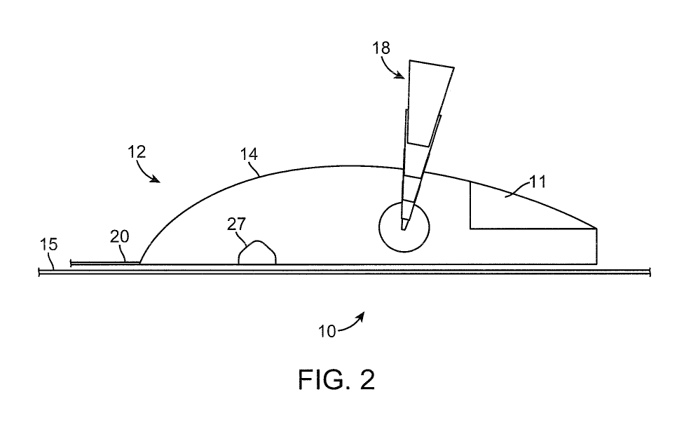

FIG. 2 shows a side view of the input device 10 including the skirt 20 at the back of the mouse 12, shown on a support surface 15 such as a mouse pad. Preferably, the skirt 20 is large enough that the heel of a typical human hand would be able to apply downward pressure on the skirt 20 to maintain the skirt against the surface 15, and thus stop the mouse from moving as desired.

The mouse may include button(s) 11 and a joystick 18 mounted on the body 14 (the joystick is not a required feature of the mouse). In one example, when using the mouse 12 for controlling position, the heel of the hand need not be pressed down on the skirt 20, but may lightly rest on it in the same way that the heel rests on a mouse mat.

When the joystick 18 is used, then pressure can be applied on the skirt 20 by the heel of the hand to prevent the mouse 12 from moving on the support surface (allowing position control by the joystick).

The skirt 20 does not interfere with the normal operation of the mouse since it is sized such that the heel of the hand will naturally hover over the skirt, or rest lightly on it, without preventing free movement of the mouse.

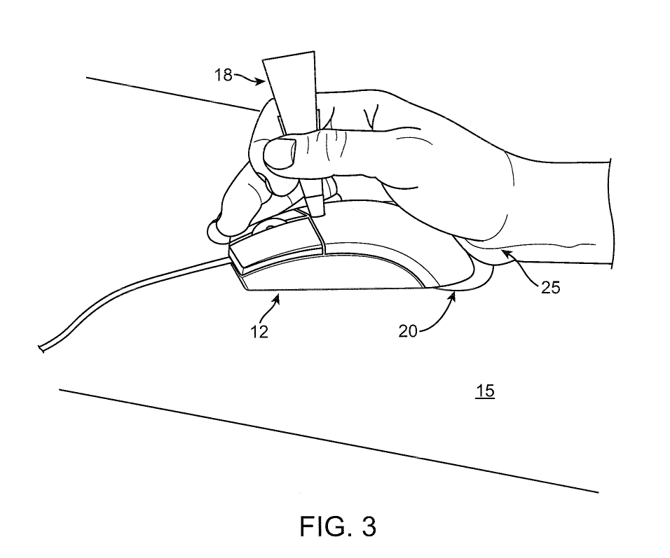

As also shown in FIG. 3, the mouse skirt 20 is shown attached to the back end of the mouse 12 and may be an extension of the mouse casing and as such made of plastic, or fabric which may then be detached. When the joystick 18 is to be used, pressure is applied over the top of the skirt 20 by the heel 25 of the hand to prevent the mouse from moving. For example, the joystick can be gripped between the thumb and forefinger and used for input with the heel of the hand pressing the skirt against the support surface 15 under the mouse 12 and skirt 20, to prevent the mouse 12 from moving.

The skirt can be a separate element from the mouse body that is detachably attached to the mouse body via fastening means. The skirt can be detached, and reattached, as desired. The skirt is preferably selected to be thin enough to be unobtrusive under the heel of the hand, but strong enough to withstand the pressure required to keep the mouse stationary (e.g., about 2 millimeters based on the material). The surface area of the skirt can be selected as desired.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The invention has been described in considerable detail with reference to certain preferred versions thereof, however, other versions are possible. Therefore, the spirit and scope of the appended claims should not be limited to the description of the preferred versions contained herein.

What is claimed is:

1. A position input device, comprising:
a mouse module configured for providing position information, the mouse including a body; and
a skirt element attached to the mouse body and extending from a lower surface of the mouse body, for maintaining the mouse in an essentially stationary position on a support surface by holding the skirt against a surface under the mouse module.

2. The input device of claim 1, wherein the skirt is positioned and configured on the mouse body to allow maintaining the mouse against the support surface by the heel of a user hand.

3. The input device of claim 1, wherein the skirt is substantially planar and extending from the mouse body at a position for resting the heel of a user hand thereon.

4. The input device of claim 1, wherein the skirt is detachably attached to the mouse body.
